(19) United States
(12) Patent Application Publication
(10) Pub. No.: US 2019/0274473 A1
(43) Pub. Date: Sep. 12, 2019

(54) AUTOMATIC DRIP COFFEE MACHINE

(71) Applicant: BSEC ELECTRONICS CO., LTD., Incheon (KR)

(72) Inventor: Ja Sung KIM, Seoul (KR)

(73) Assignee: BSEC ELECTRONICS CO., LTD., Incheon (KR)

(21) Appl. No.: 16/422,148

(22) Filed: May 24, 2019

Related U.S. Application Data
(63) Continuation-in-part of application No. 15/433,095, filed on Feb. 15, 2017.

(30) Foreign Application Priority Data
Feb. 15, 2016 (KR) 10-2016-0017000

(51) Int. Cl. A47J 31/52; A47J 31/057; A47J 31/44; A47J 31/46

(52) U.S. Cl. CPC A47J 31/5255; A47J 31/057; A47J 31/5253; A47J 31/465; A47J 31/4475

(57) ABSTRACT

An automatic drip coffee machine includes a drip part, a hot water supply unit, a pedestal, a load cell, and a controlling part. The drip part pours water into a dripper containing ground coffee beans in a predetermined amount to brew coffee. The hot water supply unit heats water and provides the heated water to the drip part. The pedestal supports a drip container for supporting the dripper and storing the extracted coffee by the dripper. The load cell is disposed in the pedestal and measures weights of the dripper and the drip container so as to measure an amount of water actually poured from the drip part into the dripper. The controlling part adjusts a temperature of the water stored the hot water supply unit and sets a water injection amount of the drip part to be poured into the dripper.

### CROSS-REFERENCE TO RELATED APPLICATION

This application is a continuation-in-part application of U.S. patent application Ser. No. 15/433,095, filed Feb. 15, 2017 (now pending), the disclosure of which is herein incorporated by reference in its entirety. The U.S. patent application Ser. No. 15/433,095 claims the priority benefit of Korean Patent Application No. 10-2016-0017000, filed on Feb. 15, 2016, and all the benefits accruing therefrom under 35 U.S.C. § 119, the contents of which are incorporated by reference in their entirety.

### TECHNICAL FIELD

Example embodiments disclosure relate to a coffee drip machine, and more particularly, to an automatic coffee drip machine capable of automatically dripping coffee in a hand drip manner (a pour-over manner).

### BACKGROUND

In general, a coffee brewing method includes an espresso coffee brewing method using a booster feed water pump and a drip coffee brewing method using a water stream falling by gravity.

The drip coffee brewing method includes a drip method using an electric coffee-maker and a hand drip method (a pour-over method) in which a user directly pours water onto ground coffee beans.

The drip method using an electric coffee-maker is a method of automatically brewing coffee by supplying ground coffee beans and water to the electric coffee-maker, and has the merits that the coffee brewing method is simple and brewed coffee can be kept warm for a long time. However, when a large amount of ground coffee beans are brewed and kept warm, the drip method using an electric coffee-maker remarkably reduces taste and flavor of coffee. And, the longer the electric coffee-maker keeps the brewed coffee, the more it has a burnt taste of the brewed coffee. Also, the drip method using an electric coffee-maker extracts pernicious ingredients contained ground coffee beans, because the electric coffee-maker brews coffee and water path through ground coffee beans for hours. Further, in the process of extracting coffee, the taste and flavor of coffee are deteriorated because coffee is extracted with a lot of impure taste.

The hand drip method is a manual coffee brewing method, in which a user puts ground coffee into a dripper on which a coffee paper is positioned, and then pours boiling water onto the ground coffee using a drip pot thereby extracting coffee. This method has the merits that the taste and flavor of coffee can be maximized better than the drip method using the electric coffee-maker because the user can adjust the method of pouring water according to properties of each coffee bean type and type of the dripper. However, because the hand drip method pours water by hand, the coffee brewing recipe is different for each person. Also, the amount, speed, and direction of pouring water onto the ground coffee are irregular, and it is difficult to supply water in a set amount for each of pouring turns.

In an automatic drip coffee machine of adopting the hand drip method, the automatic drip coffee machine include a water tank, a drip part and a motor for providing water from the water tank through the drip part.

However, as the motor has been operated for a long time, an operation error of the motor might occur due to a deterioration or failure of the motor for supplying water from the tank. Thus, it might be difficult for the motor to supply the drip part with water having a predetermined amount from the water tank.

In addition, according to a species of the coffee or a grinding degree of the ground coffee, there may been different in an amount of water absorbed by the ground coffee and an amount of the water passing through the dripper.

Furthermore, variations in the temperature of the water may occur while the water is being supplied from the water tank to the dripper.

As a result, the taste of coffee may be changed every time it is brewed and different depending on who has brewed the coffee. As a prior art related to the present invention, Korean Patent No. 10-0897948 (issued on May 8, 2009) is disclosed.

### SUMMARY

The present disclosure provides an automatic drip coffee machine capable of automatically brewing coffee in the hand drip manner by pouring water in a set amount.

In accordance with an aspect of the present invention, an automatic drip coffee machine may include a drip part pouring water into a dripper containing ground coffee beans in a predetermined amount to brew coffee, a hot water supply unit heating water and providing the heated water to the drip part, a pedestal supporting a drip container for supporting the dripper and storing the extracted coffee by the dripper, a load cell disposed in the pedestal and measuring weights of the dripper and the drip container so as to measure an amount of water actually poured from the drip part into the dripper, and a controlling part adjusting a temperature of the water stored the hot water supply unit and setting a water injection amount of the drip part to be poured into the dripper. In particularly, the controlling part may calculate an error value between a predetermined water injection amount of the drip part and an amount of water actually poured from the drip part into the dripper using weights of the dripper and the drip container measured by the load cell and may readjust the water injection amount of the drip part based on the error value.

In accordance with some exemplary embodiments of the present disclosure, the automatic drip coffee machine may further include an input part for receiving a menu setting command for brewing coffee by an operation of a user. In particularly, the controlling part may set an amount of extracting coffee, a coffee bloom time after wetting, a number of pours, an interval between pours, and a water injection amount per a pour of the drip part based on the menu setting command inputted through the input part by the user.

In an example embodiment, the controlling part may include a data storage part configured to store data on a temperature, a flowing rate of hot water and a flow amount of hot water, an input part configured to receive data on the weights measured by the load cell from the load cell, a calculator configured to calculate an amount of water actually poured from the drip part into the dripper using values of the weights of the dripper and the drip container as measured by the load cell, and configured to obtain an error value between the amount of water actually poured from the drip part into the dripper and a predetermined amount of water, and a comparator configured to determine whether the error value exceeds to a standard value.

In accordance with some exemplary embodiments of the present disclosure, the drip part may include a drip nozzle disposed above the pedestal and spraying water provided from the hot water supply unit into the dripper, a hot water supply line connected the hot water supply unit and the drip nozzle to provide the water from the hot water supply unit to the drip nozzle, and a metering pump regulating an amount and pressure of water provided from the hot water supply unit to the drip nozzle.

In accordance with some exemplary embodiments of the present disclosure, the controlling part may control the metering pump so as to adjust the water injection amount of the drip part and a water injection pressure of the drip part.

In accordance with some exemplary embodiments of the present disclosure, the controlling part may control the metering pump according to the user's menu setting command so as to adjust a water injection pressure of the drip part for each pouring turn.

In accordance with some exemplary embodiments of the present disclosure, the drip nozzle may include a plurality of injection holes for spraying water. Further, the drip nozzle may spray the water in a shower spraying manner so as to uniformity spray the water onto the ground coffee beans contained in the dripper.

In accordance with some exemplary embodiments of the present disclosure, the hot water supply unit may include a hot water tank storing water and heating the stored water to a predetermined temperature, and a temperature sensor sensing a temperature of water stored in the hot water tank so as to transmit the sensed temperature to the controlling part. In particularly, the controlling part may adjust the temperature of water stored in the hot water tank based on the sensed temperature received from the temperature sensor.

Here, the hot water supply unit may include a supply line configured to connect the hot water tank with the drip part to provide a flow path for supplying the hot water, and a circulation line branched from an end portion of the supply line and connected to the hot water tank so as to circulate the hot water.

Further, the hot water supply unit may further include a three-way valve provided at a branch point between the supply line and the circulation line.

According to the example embodiments of the present invention, the automatic drip coffee machine may readjust the water injection amount of the drip part by comparing the amount of water actually injected from the drip part into the dripper with the predetermined water injection amount of the drip part. Accordingly, the water injection amount error of the drip part due to the driving error of the metering pump may be reduced, and a set amount of water may be accurately poured into the ground coffee beans contained in the dripper. As a result, the automatic drip coffee machine may improve and maintain the flavor and taste of the coffee.

Also, the automatic drip coffee machine may set the coffee bloom time, the number of pours, the interval between pours, and so on by the user' operation. Accordingly, the automatic drip coffee machine may brew coffee that suits user's taste rather than uniformly having the same taste and flavor, and may brew coffee in a manner suited to each kind of coffee bean varieties and the type of the dripper. As a result, the automatic drip coffee machine may improve the quality of service.

### BRIEF DESCRIPTION OF THE DRAWINGS

Exemplary embodiments can be understood in more detail from the following description taken in conjunction with the accompanying drawings, in which:

FIG. 1 is a perspective view illustrating an automatic drip coffee machine in accordance with an exemplary embodiment of the present invention;

FIG. 2 is an internal schematic view illustrating the automatic drip coffee machine in FIG. 1;

FIG. 3 is a schematic view illustrating the operation relationship between the internal components of the automatic drip coffee machine in FIG. 2;

FIG. 4 is a plan view illustrating a drip nozzle in FIG. 3;

FIG. 5 is a block diagram illustrating the controlling part in FIG. 2;

FIG. 6 is a flow chart illustrating an operation of the controlling part in FIG. 2; and

FIG. 7 is a block diagram illustrating a hot water supplying unit in FIG. 2

### DETAILED DESCRIPTION OF EMBODIMENTS

Hereinafter, embodiments of the present invention are described in more detail with reference to the accompanying drawings. However, the present invention is not limited to the embodiments described below and is implemented in various other forms. Embodiments below are not provided to fully complete the present invention but rather are provided to fully convey the range of the present invention to those skilled in the art.

In the specification, when one component is referred to as being on or connected to another component or layer, it can be directly on or connected to the other component or layer, or an intervening component or layer may also be present. Unlike this, it will be understood that when one component is referred to as directly being on or directly connected to another component or layer, it means that no intervening component is present. Also, though terms like a first, a second, and a third are used to describe various regions and layers in various embodiments of the present invention, the regions and the layers are not limited to these terms.

Terminologies used below are used to merely describe specific embodiments, but do not limit the present invention. Additionally, unless otherwise defined here, all the terms including technical or scientific terms, may have the same meaning that is generally understood by those skilled in the art.

Embodiments of the present invention are described with reference to schematic drawings of ideal embodiments. Accordingly, changes in manufacturing methods and/or allowable errors may be expected from the forms of the drawings. Accordingly, embodiments of the present invention are not described being limited to the specific forms or areas in the drawings, and include the deviations of the forms. The areas may be entirely schematic, and their forms may not describe or depict accurate forms or structures in any given area, and are not intended to limit the scope of the present invention.

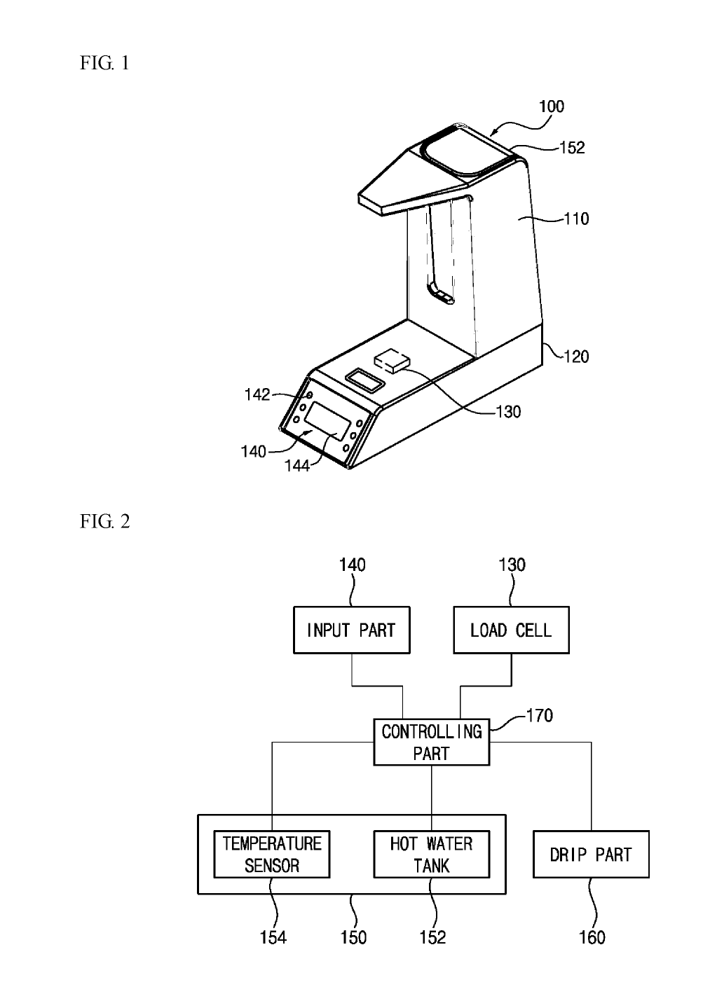

FIG. 1 is a perspective view illustrating an automatic drip coffee machine in accordance with an exemplary embodiment of the present invention, and FIG. 2 is an internal schematic view illustrating the automatic drip coffee machine in FIG. 1.

Referring to FIGS. 1 and 2, in accordance with and exemplary embodiment of the present disclosure, an automatic drip coffee machine 100 is capable of automatically brewing coffee in a hand drip manner (a pour-over manner), and may include a housing 110 and a pedestal 120 disposed under the housing 110.

A drip container such as a drip server for storing extracted coffee by the automatic drip coffee machine 100 may be placed on the pedestal 120, and a dripper is covered by a coffee paper for filtering ground coffee. Further, the drip container may support the dripper for coffee brewing by placing the dripper thereon.

A load cell 130 may be disposed in the pedestal 120. The load cell 130 may measure weights of both the dripper when receiving the coffee paper and the ground coffee and the drip container in order to measure an amount of water actually poured from the automatic drip coffee machine 100 into the dripper. That is, when the pedestal 120 supports the drip container and the dripper of receiving the coffee paper and the ground coffee, the load cell 130 measure the weight of the dripper and the drip container. Here, the coffee paper and the ground coffee are placed on the dripper.

An input unit 140 may be disposed on a front surface of the pedestal 120 to receive a command by a user's operation. As shown in FIG. 1, the input unit 140 may include a menu button 142 for the user to input the command, and a display part 144 for displaying a current state of the automatic drip coffee machine 100, an input menu and so on.

In an example embodiment, the input unit 140 is disposed on the front surface of the pedestal 120 but may be disposed on one side of the housing 110.

Meanwhile, a hot water supply unit 150 for heating and storing water, a drip part 160 for pouring water in a set amount into the dripper, and a controlling part 170 may be disposed in the housing 110.

The hot water supply unit 150 may store water and heat the stored water to a predetermined temperature. Also, the hot water supply unit 150 may be supply the heated water to the drip part 160. The drip part 160 may pour the heated water into the dripper in a predetermined amount to brew coffee. The hot water supply unit 150 and the drip part 160 are controlled by the controlling part 170. The controlling part 170 may control the hot water supply unit 150 and the drip part 160 according to the command input through the input unit 140.

Hereinafter, components of the hot water supply unit 150 and the drip part 160, and operation of the hot water supply unit 150, the drip part 160 and the controlling part 170 will be explained in detail with reference to the accompanying drawings.

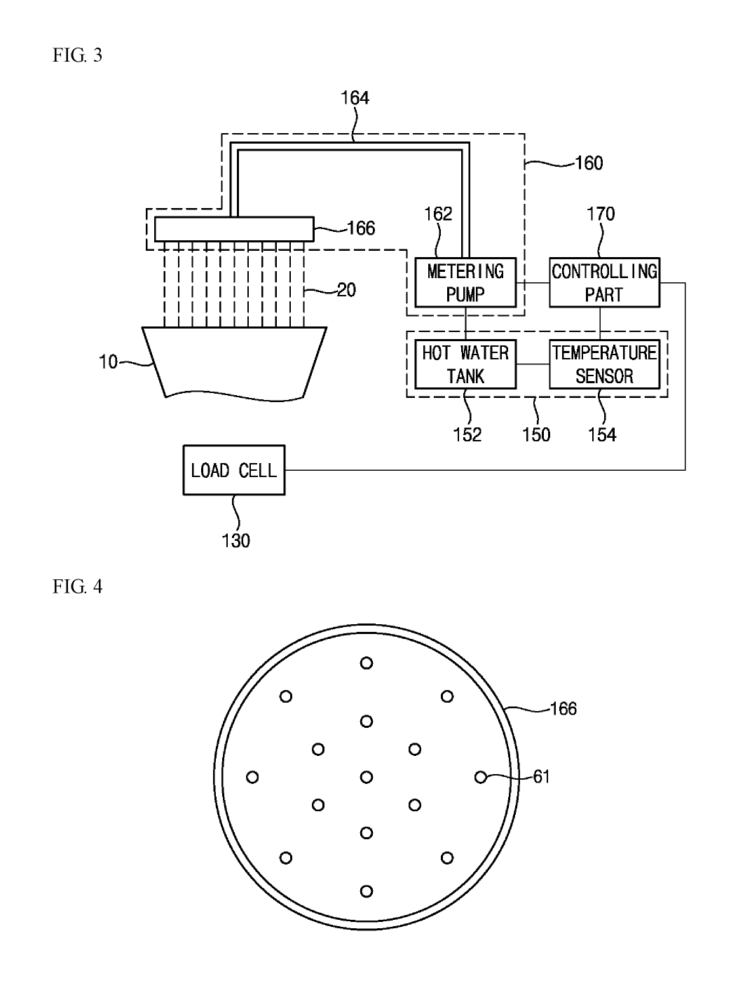

FIG. 3 is a schematic view illustrating the operation relationship between the internal components of the automatic drip coffee machine as shown in FIG. 2, and FIG. 4 is a plan view illustrating a drip nozzle as shown in FIG. 3.

Referring to FIGS. 2 to 4, the hot supply unit 150 may include a hot water tank 152 and a temperature sensor 154. The hot water tank 152 may store water and heat the stored water to the predetermined temperature. The temperature sensor 154 may sense a temperature of water stored in the hot water tank 152, and transmit the sensed temperature to the controlling part 170. The controlling part 170 may adjust the temperature of the water stored in the hot water tank 152 according to the sensed temperature received from the temperature sensor 154. Although not shown in figures, the hot water tank 152 may include a heater to heat the stored water.

The water stored in the hot water tank 152 may be provided to the drip part 160 to brew coffee. The drip part 160 may include a metering pump 162, a hot water supply line 164, and a drip nozzle 166.

In detail, the water stored in the hot water tank 152 is provided to the drip nozzle 166 through the hot water supply line 164. The drip nozzle 166 pours the provided water onto ground coffee beans contained in the dripper 10. At this time, the metering pump 162 may regulate the amount and pressure of water provided from the hot water tank 152 to the hot water supply line 164 under the control of the control part 170, as a result, the drip nozzle 166 may pour water onto the ground coffee beans in a predetermined amount at a predetermined pressure.

However, if the metering pump 162 malfunctions, an error may occur in the amount of water supplied to the drip part 160 through the hot water supply pipe 164 and the injection nozzle 166. For example, when the metering pump 162 is used for a long time, the amount of the water supplied to the dripping part 160 may be reduced.

The drip nozzle 166 may be disposed above the pedestal 120 (see FIG. 1), and may have a plurality of injection holes 61 for spraying water as shown in FIG. 4.

In an example embodiment, as shown in FIG. 3, the drip nozzle 166 may spray water in a shower spraying manner so as to uniformly spray the water onto the ground coffee beans contained in the dripper 10.

The controlling part 170 may set an amount of extracting coffee, a coffee bloom time after wetting, a number of pours, an interval between pours, and a water injection amount per a pour of the drip part 160 based on a menu setting command. The menu setting command is input through the input unit 140 by the user' operation. The controlling part 170 may control the metering pump 162 according to the water injection amount per a pour per set by the user's operation. Thereby, the drip part 160 may pour the water 20 into the dripper 10 in a predetermined amount set by the user. Here, the controlling part 170 may adjust a water injection pressure of the drip part 160 differently each pouring turn. For example, a water injection pressure at the first pour after the coffee bloom and a water injection pressure at the second pour may be set to be different from each other.

In particular, the controlling part 170 may calculate an error between a predetermined water injection amount of the drip part 160 and an amount of water actually poured from the drip part 160 into the dripper 10 using the weights of the dripper 10 and the drip container measured by the load cell 130, and may readjust the water injection amount of the drip part 160 based on the calculated error value. In other words, the controlling part 170 calculates the amount of water actually injected from the drip part 160 into the dripper 10 based on the weights of the dripper 10 and the drip container measured by the load cell 130, and calculates the error between the currently set water injection amount of the drip part 160 and the measured water injection amount. The controlling part 170 controls the metering pump 162 based on the calculated error value to readjust the water injection amount of the drip part 160.

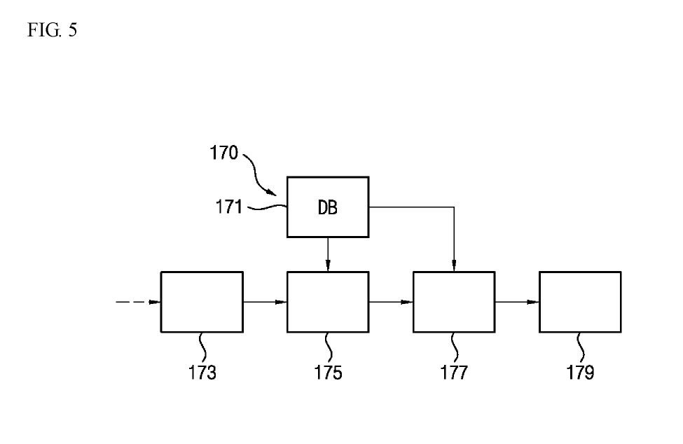

FIG. 5 is a block diagram illustrating the controlling part in FIG. 2.

Referring to FIGS. 2, 3 and 5, a controlling unit 170 according to an embodiment of the present invention includes a data storage part 171, an input part 173, a calculator 175, a comparator 177 and an output part 179.

The data storage part 171 stores data for controlling a temperature of the hot water, a supply flow amount for hot water, and a supply flow rate for hot water, etc. For example, the data storage part 171 may store data capable of controlling the supply flow amount and the supply flow rate of the hot water by adjusting a driving power or a driving time of the metering pump 162. The data may be adjusted according to a value set through the input unit 140 by the user.

The input part 173 transmits data about weights measured by the load cell 130 to the calculator 175. That is, the weights may correspond to a weight W1 of summing weights of the dripper 10 and the drip container without water, and a weight W2 of summing the weights of the dripper and drip container while supplying the hot water for the dripper and the drip container.

The calculator 175 calculates a weight of water actually poured from the drip part by using the data on the weights W1 and W2 transmitted from the input part 173. In other words, by subtracting the weight W1 of summing those of the dripper 10 and the drip container in the absence of water from the weight W2 of summing those of the dripper 10 and drip container while pouring hot water from the drip part 160, the weight of the water actually supplied to the dripper 10 may be calculated in real time. Thus, irrespective of a species of ground coffee and a grinding degree of the ground coffee, an actual weight of the water sprayed from the drip part 160 and supplied to the dripper 10 may be measured in real time.

Further, the calculator 175 calculates an error value by comparing the amount of water actually measured from the weight of the water supplied to the dripper 10 with a predetermined amount of water received from the data storage part 171. The error value may occur due to malfunction of the metering pump 162.

The comparator 177 determines whether the error value exceeds to a standard value. Accordingly, when the error value exceeds to the standard value, the amount of water supplied from the drip part 160 may be controlled by adjusting a driving power or a driving time of the metering pump 162.

In particular, the controlling unit 170 may control the amount of actually poured water. That is, the controlling unit 170 measures the amount of actually poured water in real time and performs a proportional integral differential (PID) analysis to calculate the flow rate of the hot water. Further, the flow rate of the hot water may be changed by changing the driving power of the metering pump 162 by a pulse width modulation (PWM) control according to various steps of dripping coffee.

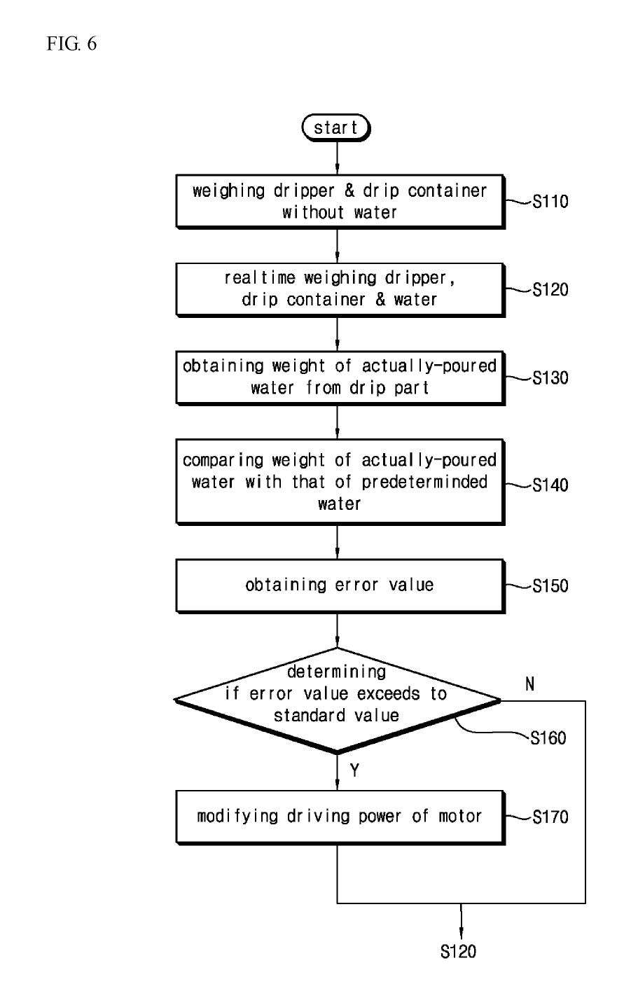

FIG. 6 is a flow chart illustrating an operation of the controlling part in FIG. 2.

Referring to FIGS. 2, 5 and 6, first, a first weight W1 of summing those of the dripper and the drip container without water is measured (S110).

Then, a second weight W2 of summing those of the dripper and the drip container with water, while water is supplied to the dripper, is measured (S120).

Next, a weight of the water actually poured to the dripper is calculated using the data on the weights W1 and W2 (S130). In other words, by subtracting the weight W1 of summing those of the dripper and the drip container without water from the weight W2 of summing those of the dripper and the drip container with water, the weight of the actually poured water into the dripper may be calculated in real time. Thus, irrespective of the species of ground coffee and the grinding degree of the ground coffee, the weight of the water sprayed from the drip part supplied to the dripper.

Thereafter, after the amount of water is obtained using the weight of the water and the density of the water, then, the amount actually poured to the dripper is compared with and the predetermined amount of water received from the data storage (S140).

Thereby, an error value with respect to the amount of actually poured water is calculated (S150). The error value may occur due to malfunction of the metering pump.

Then, whether the error value exceeds to a standard value is determined (S160).

Then, when the error value exceeds to the standard value, the driving power or driving time of the metering pump is modified to control the amount of water supplied to the dripping part.

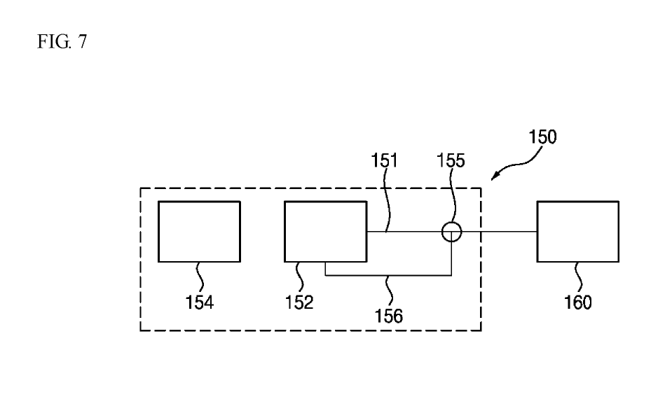

FIG. 7 is a block diagram illustrating a hot water supplying unit in FIG. 2

Referring to FIGS. 2, 3 and 7, a hot water supply unit 150 according to an example embodiment of the present invention includes a hot water tank 152, a temperature sensor 154, a supply line 151, a circulation line 156, and a three-way valve 155.

The hot water tank 152 can store water and heat the stored water to a predetermined temperature.

The temperature sensor 154 may sense the temperature of the water stored in the hot water tank 152 and provide the temperature measurement value to the controlling part 170. Accordingly, the controlling part 170 may adjust the temperature of the water stored in the hot water tank 152 according to a value of temperature received from the temperature sensor 154.

The supply line 151 connects between the hot water tank 152 and the drip part 160. Thus, the supply line 151 may provide a flow path through which hot water flow from the hot water tank 152 to the drip part 160.

The circulation line 156 branches from a branch point provided at an end of the supply line 151 and is connected to the hot water tank 152. The circulation line 156 circulates the hot water flowing from the hot water tank 152 through the supply line 151 back to the hot water tank 152.

The three-way valve 155 is provided at the branch point. The three-way valve 155 may selectively control the hot water to flow the hot water flowing through the supply line 151 to the drip part 160 or the hot water tank 152.

Therefore, the hot water supply unit 150 is provided with the three-way valve 155, so that the hot water remaining in the supply line 151 may be circulated to the hot water tank 152. Thereby, the temperature of the hot water supplied to the drip part 160 may be suppressed from cooling the hot water while initially flowing through the supply line 151. As a result, the temperature of the hot water supplied to the dripper may be kept constant, so that the automatic drip coffee apparatus 100 may maintain coffee taste constant.

As described above, the automatic drip coffee machine 100 may readjust the water injection amount of the drip part 160 by comparing the amount of water actually injected from the drip part 160 into the dripper 10 with the predetermined water injection amount of the drip part 160. Accordingly, the water injection amount error of the drip part 160 due to the driving error of the metering pump 162 may be reduced, and a set amount of water may be accurately poured into the ground coffee beans contained in the dripper 10. As a result, the automatic drip coffee machine 100 may improve and maintain the flavor and taste of the coffee.

Further, the automatic drip coffee machine 100 may set the coffee bloom time, the number of pours, the interval between pours, and so on by the user' operation. Accordingly, the automatic drip coffee machine 100 may brew coffee that suits user's taste rather than uniformly having the same taste and flavor, and may brew coffee in a manner suited to each kind of coffee bean varieties and the type of the dripper 10. As a result, the automatic drip coffee machine 100 may improve the quality of service.

Although the automatic drip coffee machine has been described with reference to specific embodiments, they are not limited thereto. Therefore, it will be readily understood by those skilled in the art that various modifications and changes can be made thereto without departing from the spirit and scope of the present disclosure defined by the appended claims.

What is claimed is:

1. An automatic drip coffee machine comprising:
a drip part configured to pour water into a dripper receiving a coffee paper and ground coffee on the coffee paper in a predetermined amount to brew coffee;
a hot water supply unit configured to heat water and to provide heated water to the drip part;
a pedestal configured to support a drip container for supporting the dripper and storing coffee extracted from the dripper;
a load cell disposed in the pedestal, and configured to measure weights of the dripper and the drip container and to measure an amount of water actually poured from the drip part into the dripper; and
a controlling part configured to adjust a temperature of the water stored in the hot water supply unit and set a water injection amount of the drip part to be poured into the dripper, wherein the controlling part is further configured to calculate an error value between a predetermined water injection amount of the drip part and an amount of water actually poured from the drip part into the dripper obtained using values of weights of the dripper and the drip container as measured by the load cell and is configured to readjust the water injection amount of the drip part based on the error value.

2. The automatic drip coffee machine of claim 1, further comprising an input part configured to receive a menu setting command for brewing coffee by an operation of a user, wherein the controlling part is configured to set an amount of extracting coffee, a coffee bloom time after wetting, a number of pours, an interval between pours, and a water injection amount per a pour of the drip part based on the menu setting command inputted through the input part by the user.

3. The automatic drip coffee machine of claim 1, wherein the controlling part comprises:
a data storage part configured to store data on a temperature, a flowing rate of hot water and a flow amount of hot water;
an input part configured to receive data on the weights measured by the load cell from the load cell;
a calculator configured to calculate an amount of water actually poured from the drip part into the dripper using values of the weights of the dripper and the drip container as measured by the load cell, and configured to obtain an error value between the amount of water actually poured from the drip part into the dripper and a predetermined amount of water; and
a comparator configured to determine whether the error value exceeds to a standard value.

4. The automatic drip coffee machine of claim 1, wherein the drip part comprises a drip nozzle disposed above the pedestal and spraying water provided from the hot water supply unit into the dripper, a hot water supply line connected the hot water supply unit and the drip nozzle configured to provide the water from the hot water supply unit to the drip nozzle, and a metering pump configured to regulate an amount and pressure of water provided from the hot water supply unit to the drip nozzle.

5. The automatic drip coffee machine of claim 4, wherein the controlling part is configured to control the metering pump to adjust the water injection amount of the drip part and a water injection pressure of the drip part.

6. The automatic drip coffee machine of claim 4, wherein the controlling part is further configured to control the metering pump according to a user's menu setting command so as to adjust a water injection pressure of the drip part for each pouring turn.

7. The automatic drip coffee machine of claim 4, wherein the drip nozzle comprises a plurality of injection holes configured to spray water and sprays the water in a s uniform spray pattern onto the ground coffee contained in the dripper.

8. The automatic drip coffee machine of claim 1, wherein the hot water supply unit includes a hot water tank configured to store water and heating the stored water to a predetermined temperature, and a temperature sensor configured to sense a temperature of water stored in the hot water tank to transmit the sensed temperature to the controlling part.

9. The automatic drip coffee machine of claim 8, wherein the controlling part is configured to adjust the temperature of water stored in the hot water tank based on the sensed temperature received from the temperature sensor.

10. The automatic drip coffee machine of claim 8, wherein the hot water supply unit comprises:
a supply line configured to connect the hot water tank with the drip part to provide a flow path for supplying the hot water; and
a circulation line branched from an end portion of the supply line and connected to the hot water tank so as to circulate the hot water.

11. The automatic drip coffee machine of claim 10, wherein the hot water supply unit further comprises a three-way valve provided at a branch point between the supply line and the circulation line.
